(19) United States
(12) Patent Application Publication
(10) Pub. No.: US 2017/0026760 A1
(43) Pub. Date: Jan. 26, 2017

(54) MICROPHONE WITH HUMIDITY SENSOR

(71) Applicant: Knowles Electronics, LLC, Itasca, IL (US)

(72) Inventors: John J. Albers, Chicago, IL (US); Joshua Watson, Aurora, IL (US); Kurt B. Friel, Sycamore, IL (US); Norman Dennis Talag, Woodridge, IL (US); Sung Bok Lee, Chicago, IL (US)

(73) Assignee: Knowles Electronics, LLC, Itasca, IL (US)

(21) Appl. No.: 15/216,630

(22) Filed: Jul. 21, 2016

Related U.S. Application Data
(60) Provisional application No. 62/196,113, filed on Jul. 23, 2015.
(60) Provisional application No. 62/196,084, filed on Jul. 23, 2015.

(51) Int. Cl. H04R 23/00; G01N 27/22

(52) U.S. Cl. CPC H04R 23/00; G01N 27/223; H04R 2201/003

(57) ABSTRACT

Various embodiments relating to microphone with integrated sensor are disclosed herein. In one implementation, a sensor is disposed in, on, integrated with, and/or at the lid of a micro electro mechanical system (MEMS) microphone. In another implementation, a sensor is disposed at or integrated with an insert, over which a micro electro mechanical system (MEMS) device is disposed in a MEMS microphone. In disposing the sensor at the lid or insert, significant space savings are achieved. Consequently, a small-sized microphone is provided and achieved allowing the microphone deployed in applications where miniaturization is required or advantageous.

### CROSS-REFERENCE TO RELATED APPLICATIONS

This application claims the benefit of and priority to U.S. Provisional Patent Application No. 62/196,084, filed Jul. 23, 2015, and U.S. Provisional Patent Application No. 62/196,113, filed Jul. 23, 2015, the entire contents of which are incorporated herein by reference.

### TECHNICAL FIELD

This application relates to microphones and, more specifically, to microphones that include sensors.

### BACKGROUND OF THE INVENTION

Different types of acoustic devices have been used through the years. One type of device is a microphone. In a microelectromechanical system (MEMS) microphone, a MEMS die includes a diagram and a back plate. The MEMS die is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential of the back plate, which creates an electrical signal. Microphones are deployed in various types of devices such as personal computers or cellular phones.

In many different situations, it is desirable to have sensors deployed with, within, or at the microphone. For example, in cellular phones it is often desirable to know the outside temperature and/or humidity for various reasons or applications. Sensor chip-like elements have been deployed in microphones. However, these sensors are bulky and take up space. Because of their size, they increase the microphone size, and this is not desirable in many situations. In many situations, the size of the microphone is fixed, and so placing a sensor in the microphone may be impossible to do within the size constraints.

The problems of previous approaches have resulted in some user dissatisfaction with these previous approaches.

### SUMMARY

In general, one aspect of the subject matter described in this specification can be embodied in a microphone. The microphone comprises a base, a micro electro mechanical system (MEMS) device including a diaphragm and a back plate, an integrated circuit connected to the MEMS device, and a lid having a sensor. The base and the lid enclose the MEMS device and the integrated circuit.

Another aspect of the subject matter can be embodied in a microphone. The microphone comprises a lid, a micro electro mechanical system (MEMS) device including a diaphragm and a back plate, an integrated circuit connected to the MEMS device, and an insert having a sensor. The base and the lid enclose the MEMS device and the integrated circuit. The MEMS device is disposed over the insert.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 comprises a diagram of a microphone according to various embodiments.

FIG. 2 comprises a side cutaway view of the microphone of FIG. 1 according to a first implementation.

FIG. 3 comprises a view of the underside of the lid according to various embodiments.

FIG. 4 comprises a perspective view of the underside of the lid according to various embodiments.

FIG. 5 comprises a close-up cutaway view of the underside of the lid according to various embodiments.

FIG. 6 comprises a cross section the humidity sensor showing the lid, two portions of the capacitor, coating, and base metal according to various embodiments.

FIG. 7 comprises a diagram of a microphone according to various embodiments.

FIG. 8 comprises a side cutaway view of the microphone of FIG. 7 according to a second implementation.

FIG. 9 comprises an exploded view of some of the microphone elements according to various embodiments.

FIG. 10 comprises an assembled view of the microphone components of FIG. 9.

FIG. 11 comprises a perspective drawing of a spacer according to various embodiments.

FIG. 12 comprises an exploded view of a spacer with a temperature sensor according to various embodiments.

FIG. 13 comprises an assembled view of the spacer of FIG. 12.

FIG. 14 comprises an exploded view of a spacer with a temperature sensor according to various embodiments.

FIG. 15 comprises an assembled view of the spacer of FIG. 14 according to various embodiments of the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

Referring to the figures generally, various embodiments disclosed herein relate to microphone with integrated sensor. In one implementation, a sensor (e.g., a humidity sensor) is disposed in, on, integrated with, and/or at the lid of a micro electro mechanical system (MEMS) microphone. In disposing the sensor on the lid, significant space savings are achieved. Consequently, a small-sized microphone is provided and achieved allowing the microphone deployed in applications where miniaturization is required or advantageous. In another implementation, a sensor (e.g., a temperature sensor, or a humidity sensor) is disposed at or integrated with an insert, over which a micro electro mechanical system (MEMS) device is disposed in a MEMS microphone. In disposing the sensor at the insert (and not on the base), significant space savings are achieved. Consequently, a small-sized microphone is provided and achieved allowing the microphone deployed in applications where miniaturization is required or advantageous. In addition, the insert and sensor disposed therewith provides ingress protection for contaminants that might otherwise enter the microphone.

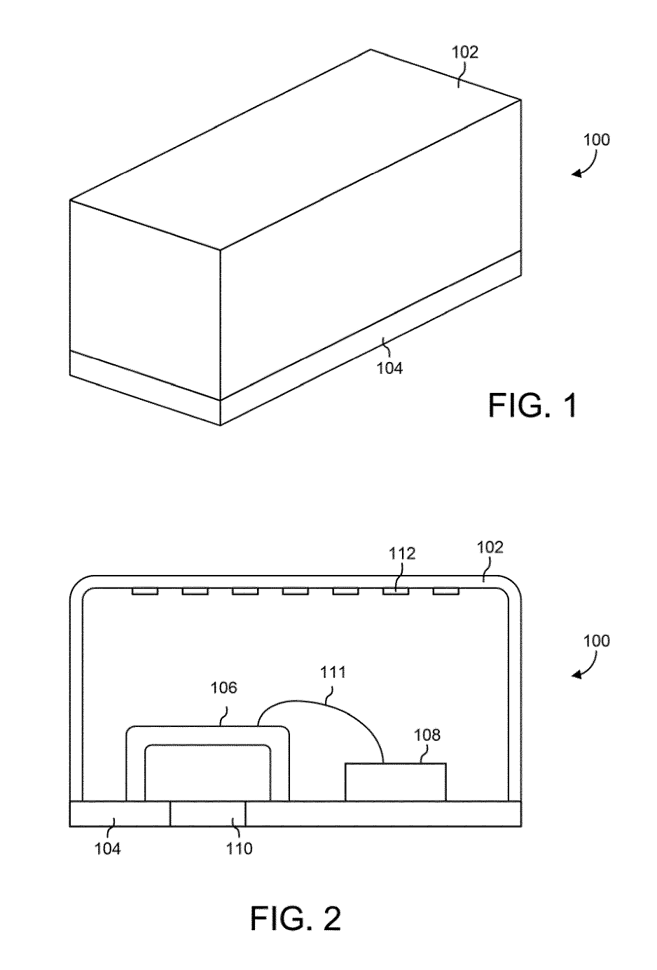

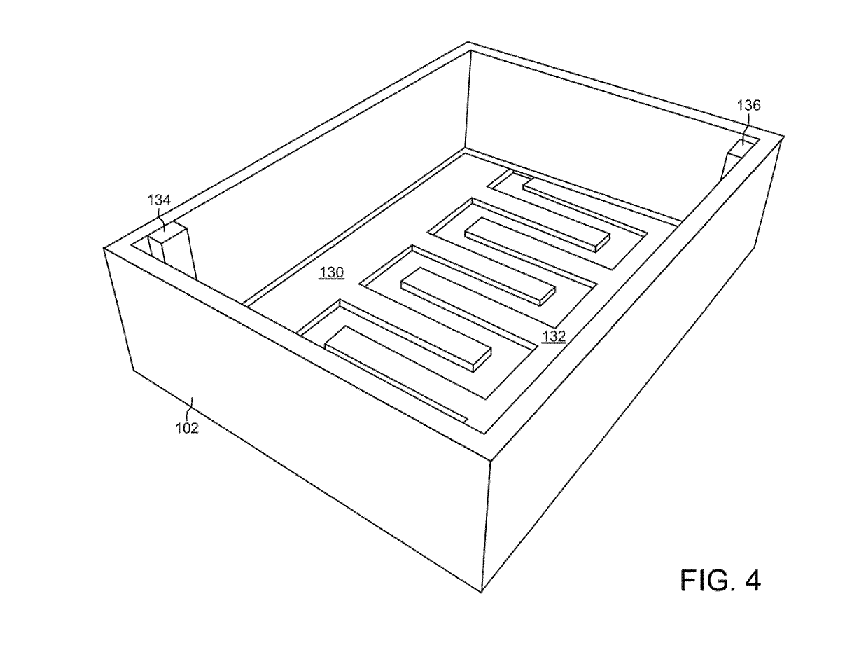

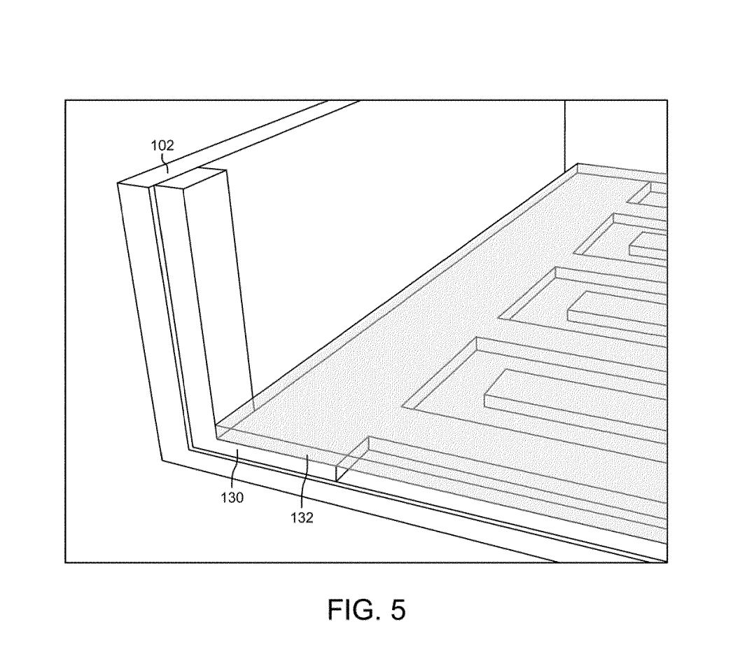

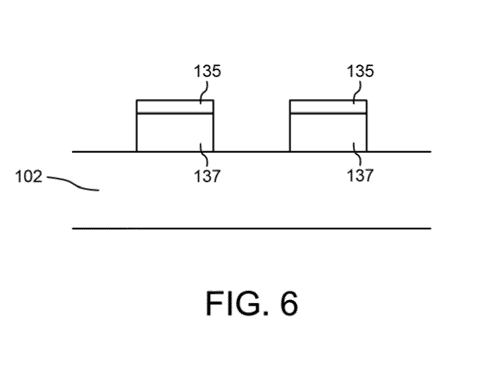

Referring now to FIGS. 1 through 6, one example of a microphone 100 including a sensor (e.g., a humidity sensor) that is embedded in, at, on, or integrated into the lid of the microphone 100 is described. The microphone 100 includes a lid 102, a base 104, a micro electro mechanical system (MEMS) device 106 (including a diaphragm and a back plate), and an integrated circuit 108.

It will be appreciated that the lid 102 in this example is a one-piece can type device. Alternatively, the lid 102 may have walls with a flat cover over the walls. In any case, the lid 102 encloses the MEMS device 106 and the integrated circuit 108. A port 110 extends through the base 104. Sound enters through the port 104, moves the diaphragm of the MEMS device 106. Electrical signal is thus created and can be transmitted by wires 111 to the integrated circuit 108.

The lid 102 has a sensor structure 112. In the example disclosed herein, the sensor structure 112 is a humidity sensor structure. It should be understood that the sensor structure 112 may be any suitable type of sensor structure. The humidity sensor structure 112 includes a first portion 130 and a second portion 132. The first portion 130 and the second portion 132 may each have metal bases 137 covered with a coating 135 that has a humidity dependent impedance. As the humidity changes, the impedance changes and this impedance is representative of the humidity.

A first lead 134 is coupled to the first portion 130. A second lead 136 is coupled to the second portion 132. Both leads 134 and 136 are coupled to the integrated circuit 108.

The integrated circuit 108 is coupled to the humidity sensor structure 112. In one example, the humidity sensor structure 112 is a comb capacitor. Humidity changes cause the impedance of the first portion 130 and the second portion 132 to change. As the humidity changes, the capacitance of the comb capacitor changes and the change in (delta) capacitance represents the change in humidity. The conversion of capacitance into a corresponding humidity may be made, for example, using a look-up table where capacitance is an index value with each index value having a corresponding humidity.

It will also be appreciated that the approaches can also be applied to MEMS on lid configurations. In this case, the MEMS device may be disposed on the lid of the microphone. A port may extend through the lid to allow sound to actuate the MEMS device. The integrated circuit 108 may also be disposed on the lid. The sensor structure 112 is disposed on the base (rather than on the lid).

In one example of the operation of the examples of FIGS. 1-6, the integrated circuit 108 senses the change in capacitance of the capacitor formed by the first portion 130 and the second portion 132. The integrated circuit 108 sensed change in capacitance and this change is representative of sensed humidity changes. The integrated circuit 108 measures this humidity, converts it into digital form, and may send this digital sensed humidity to an external electronics device. The integrated circuit 108 may couple to traces on the base and the traces may couple to external pads, and the external pads may couple to a consumer electronics device may be incorporated into a cellular phone, tablet, personal computer, or lap top to mention a few examples.

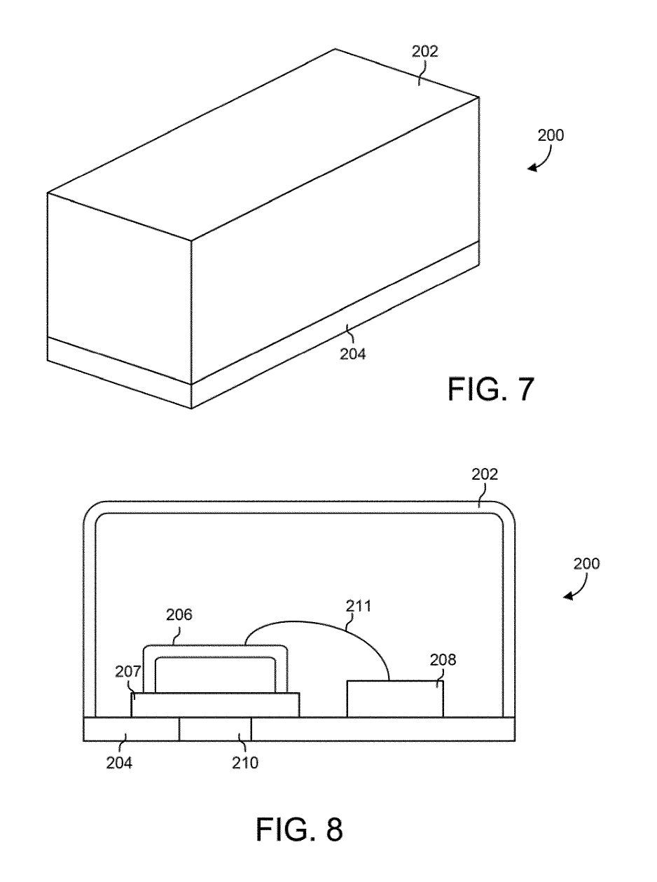

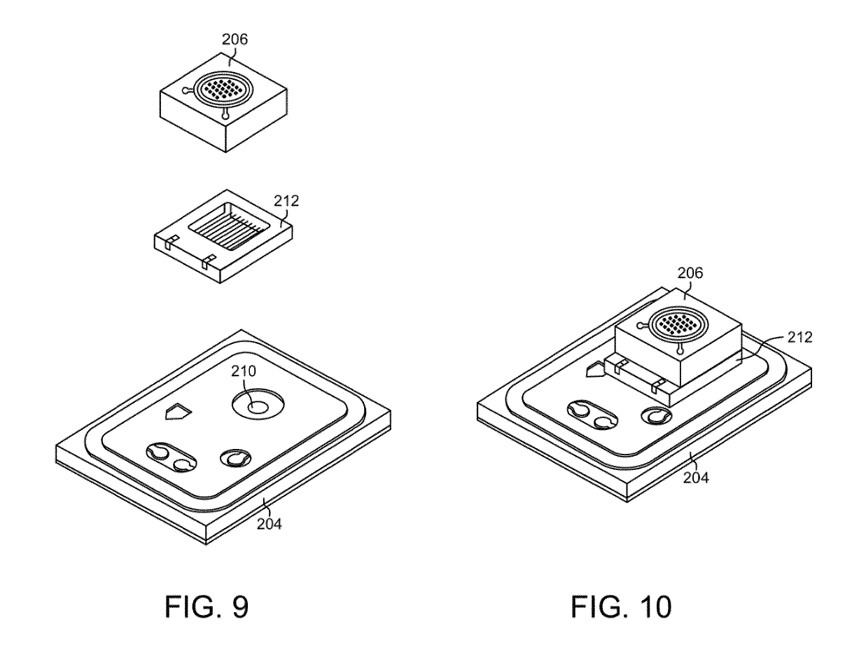

Referring now to FIGS. 7 through 10, one example of a microphone 200 including a sensor (e.g., a temperature sensor) that is embedded in, at, on, or integrated into an insert deployed with the microphone 200 is described. The microphone 200 includes a lid 202, a base 204, a micro electro mechanical system (MEMS) device 206 (including a diaphragm and a back plate); an insert 207, and an integrated circuit 208.

It will be appreciated that the lid 202 in this example is a one-piece can-type device. Alternatively, the lid 202 may be substituted with separate walls (that are coupled to the base) and with a flat cover disposed over the walls so as to enclose the interior of the microphone. In any case, the lid 202 encloses the MEMS device 206, the insert 207, and the integrated circuit 208. A port 210 extends through the base 204. Sound enters through the port 210, moves the diaphragm of the MEMS device 206. An electrical signal is thus created and can be transmitted by wires 211 to the integrated circuit 208.

The insert has a sensor structure 212. The sensor structure 212 may be configured to be a temperature sensor or a humidity sensor. Other examples of sensors are possible. The sensor structure 212 is coupled to the integrated circuit 208.

When the sensor structure 212 is configured as a temperature sensor, the sensor structure 212 can be a metallic structure that integrated into the insert 207. The sensor structure 212 is in one example a winding, snake-like structure. The resistance of the metal changes with temperature changes and this resistance (as well as changes in resistance) can be measured by the integrated circuit 208.

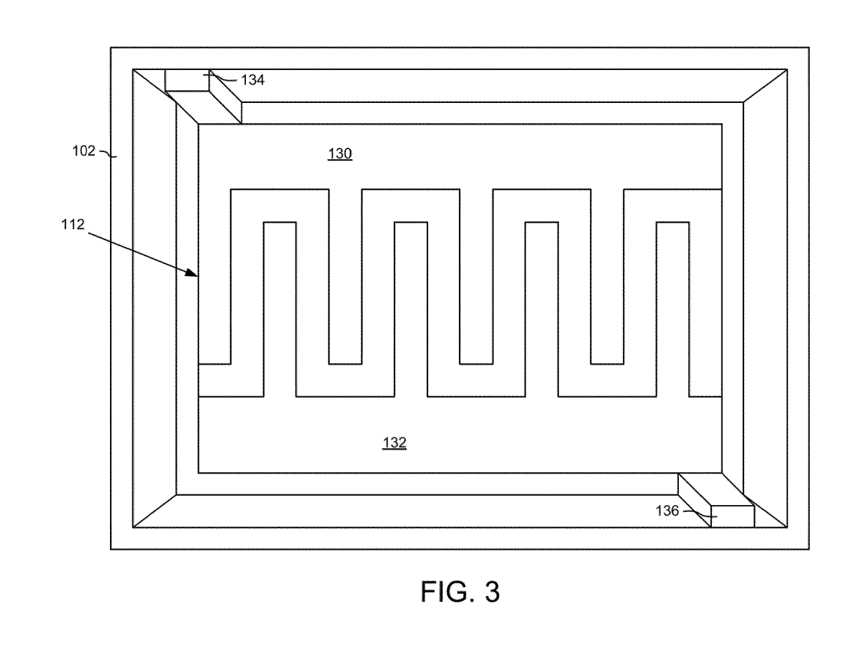

When the sensor structure 212 is configured as a humidity sensor, the sensor structure 212 may have the same structure as the humidity sensor 112 discussed above in reference to FIGS. 3-6. In particular, the sensor structure includes a first portion 130 and a second portion 132. The first portion 130 and the second portion 132 may be constructed as metal bases covered with a coating that has a humidity dependent impedance. The portions 130 and 132 form a comb capacitor with a capacitance. As the humidity changes, the capacitance changes, and the capacitance can be measured by the integrated circuit 208.

A first lead 134 is coupled to the first portion 130. A second lead 136 is coupled to the second portion 132. Both leads 134 and 136 are coupled to the integrated circuit 208.

The integrated circuit 208 is coupled to the humidity sensor structure 112. Humidity changes cause the impedance of the first portion 130 and the second portion 132 to change. As the humidity changes, the capacitance changes and the change in (delta) capacitance represents the change in humidity. The conversion of capacitance into a corresponding humidity may be made, for example, using a look-up table where capacitance is an index value with each index value having a corresponding humidity.

When the sensor structure 212 is a temperature sensor, the integrated circuit 208 drives the sensor structure 212 with a current. A delta voltage (voltage difference or differential) is measured. The delta voltage relates to the temperature. The sensor structure 212 forms an equivalent resistance and the delta voltage is measured across this resistance. An inrush of current from the integrated circuit 208 is used to measure the voltage drop across the trace. This approach effectively turns the inside of the microphone assembly into a resistive temperature device (RTD).

The integrated circuit 208 measures the temperature or humidity, converts it into digital form, and may send this digital sensed temperature or humidity to an external electronics device. The integrated circuit 208 may couple to traces on the base and the traces may couple to external pads, and the external pads may couple to a consumer electronics device may be incorporated into a cellular phone, tablet, personal computer, or lap top to mention a few examples.

It will be appreciated that the sensor structure 212 may also provide for ingress protection. The metallic windings across the openings may be sufficient to prevent particles, debris, or other contaminants from moving from the exterior of the microphone to the interior of the microphone. Additional ingress features could be used in conjunction with the sensor structure 212.

It will also be appreciated that space savings may also be achieved. By including the sensor in the insert, and placing the insert above the MEMS device, the sensor is not placed on the base. This assures that the base can be of less area than if the sensor were on the base. In other words, this placement results in a smaller footprint for the base and a smaller microphone.

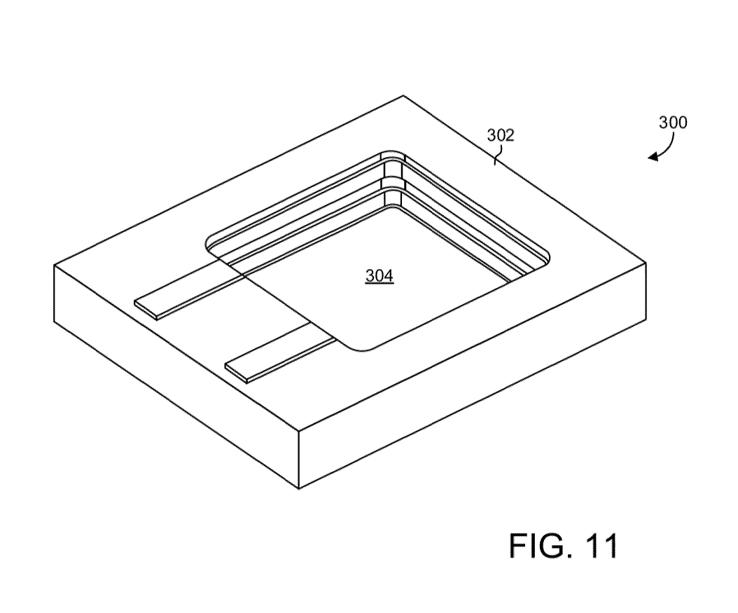

Referring now to FIG. 11, one example of a spacer 300 that can be used as the insert is described. The spacer 300 can include a temperature sensor or a humidity sensor. One function of the spacer 300 is to hold the elements forming the sensor structure.

The spacer includes a spacer housing 302 and an opening 304. A sensor structure (either temperature or humidity sensor) is disposed in the opening 304. Once the temperature or humidity are sensed, this information can be sent to the integrated circuit for additional processing. It will be appreciated that although temperature sensors and humidity sensors are described herein as examples, that other examples are possible.

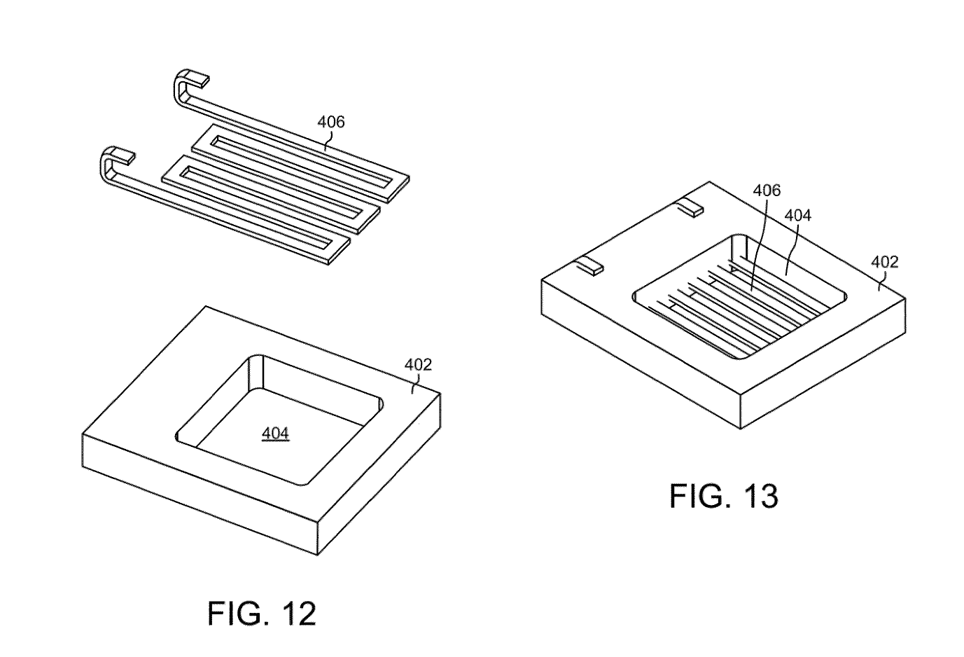

Referring now to FIG. 12 and FIG. 13, one example of a spacer that includes a temperature sensor is described.

The insert or spacer 400 includes a spacer housing 402 and an opening 404. A metallic structure 406 is disposed in the opening. The structure 406 is in one aspect a winding, snake-like structure used as a temperatures sensor.

The integrated circuit (e.g., integrated circuit 208) drives the sensor structure 406 with a current. A delta voltage (voltage difference or differential) is measured. The delta voltage relates to the temperature. The temperature sensor structure 406 forms an equivalent resistance and the delta voltage is measured across this resistance. Consequently, the temperature can be measured.

It will be appreciated that the temperature sensors may also provide for ingress protection. The windings across the openings may be sufficient to prevent particles, debris, or other contaminants from moving from the exterior of the microphone to the interior of the microphone.

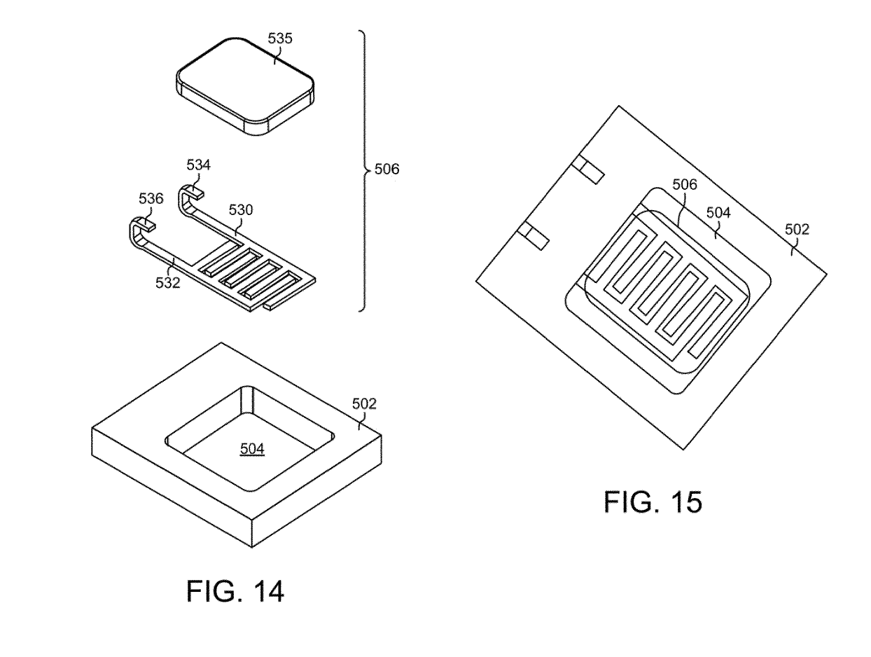

Referring now to FIG. 14 and FIG. 15, one example of a spacer that includes a humidity sensor is described.

The insert or spacer includes a spacer housing 502 and an opening 504. A structure 506 used as a humidity sensor is disposed in the opening. The structure 506 includes a first portion 530 and a second portion 532 that couple to a support 535. A first lead 534 is coupled to the first portion 530 and the integrated circuit. A second lead 536 is coupled to the second portion 532 and the integrated circuit (e.g., integrated circuit 208).

The first portion 530 and the second portion 532 may have metal bases with a coating with a humidity dependent impedance. In one example, the humidity sensor structure 506 is a comb capacitor. Humidity changes causes the impedance of the first portion 530 and the second portion 532 to change. As the humidity changes, the capacitance changes and the change in (delta) capacitance represents the change in humidity. The conversion of capacitance into a corresponding humidity may be made, for example, using a look-up table at the integrated circuit where capacitance is an index value with each index value having a corresponding humidity.

It will be appreciated that the humidity sensors may also provide for ingress protection. The first and second portions across the openings may be sufficient to prevent particles, debris, or other contaminants from moving from the exterior of the microphone to the interior of the microphone. Additional ingress features could be used in conjunction with the sensor.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A microphone comprising:
a base;
a micro electro mechanical system (MEMS) device including a diaphragm and a back plate;
an integrated circuit connected to the MEMS device; and
a lid having a sensor,
wherein the base and the lid enclose the MEMS device and the integrated circuit.

2. The microphone of claim 1, further comprising a port extending through the base or the lid.

3. The microphone of claim 1, wherein the MEMS device is disposed on the base or the lid.

4. The microphone of claim 1, wherein the integrated circuit is disposed on the base or the lid.

5. The microphone of claim 1, wherein the sensor includes a humidity sensor.

6. The microphone of claim 5, wherein the humidity sensor includes a comb capacitor that has a first portion and a second portion, wherein the first portion and the second portion each include a metal base covered with a coating that has a humidity dependence impedance, and wherein a capacitance of the comb capacitor changes with humidity.

7. The microphone of claim 5, wherein the humidity sensor is connected to the integrated circuit, and wherein the integrated circuit is configured to covert the capacitance of the comb capacitor into a corresponding humidity using a look-up table.

8. The microphone of claim 7, wherein the integrated circuit is further configured to convert the humidity into a digital form, and send the digital form to an external device.

9. A microphone comprising:
a base;
a lid;
a micro electro mechanical system (MEMS) device including a diaphragm and a back plate;
an integrated circuit connected to the MEMS device; and
an insert having a sensor,
wherein the base and the lid enclose the MEMS device and the integrated circuit, and wherein the MEMS device is disposed over the insert.

10. The microphone of claim 8, further comprising a port extending through the base.

11. The microphone of claim 10, wherein the insert is disposed over the port and prevents contaminants from entering an interior of the microphone.

12. The microphone of claim 8, wherein the sensor includes a temperature sensor or a humidity sensor.

13. The microphone of claim 8, wherein the insert includes a spacer, wherein the spacer includes a housing and an opening, and wherein the sensor is disposed in the opening.

14. The microphone of claim 13, wherein the sensor includes a temperature sensor constructed of metallic windings, and wherein a resistance of the temperature sensor changes with temperature.

15. The microphone of claim 14, wherein the temperature sensor is connected to the integrated circuit, and wherein the integrated circuit is configured to drive the temperature sensor.

16. The microphone of claim 15, wherein the integrated circuit is further configured to measure temperature, covert measurement of temperature into a digital form, and send the digital form to an external device.

17. The microphone of claim 12, wherein the sensor includes a humidity sensor, wherein the humidity sensor includes a comb capacitor that has a first portion and a second portion, wherein the first portion and the second portion each include a metal base covered with a coating that has a humidity dependence impedance, and wherein a capacitance of the comb capacitor changes with humidity.

18. The microphone of claim 17, wherein the humidity sensor is connected to the integrated circuit, and wherein the integrated circuit is configured to covert the capacitance of the comb capacitor into a corresponding humidity using a look-up table.

19. The microphone of claim 18, wherein the integrated circuit is further configured to convert the humidity into a digital form, and send the digital form to an external device.

20. The microphone of claim 19, wherein the integrated circuit is coupled to traces on the base, wherein the traces are coupled to external pads, and wherein the external pads are coupled to the external device.
